(19) United States
(12) Patent Application Publication
(10) Pub. No.: US 2004/0039669 A1
(43) Pub. Date: Feb. 26, 2004

(54) Methods for performing data processing operations associated with securities and security structures

(76) Inventors: Emerson P. Jones, Greenwich, CT (US); Joseph Todd, Summit, NJ (US); Karen Schoen, New York, NY (US)

Correspondence Address: GREENBERG TRAURIG, LLP, 885 3RD AVENUE, NEW YORK, NY, 10022, US

(21) Appl. No.: 10/440,831

(22) Filed: May 19, 2003

Related U.S. Application Data
(60) Provisional application No. 60/381,571, filed on May 17, 2002.

(51) Int. Cl. G06F 17/60

(52) U.S. Cl. 705/35

(57) ABSTRACT

One embodiment of the present invention relates to a computer implementable method for performing data processing operations associated with a security issued by an issuer, which method comprises the steps of: coupling a debt of the issuer and a warrant; structuring the warrant with the requirement to purchase a fixed number of shares of stock of the issuer; allocating proceeds from issuance of the security essentially entirely to the debt and storing data representative of the allocated proceeds; and tracking a payment status of a plurality of installment payments due on the warrant and storing data representative of the payment status so that the installment payments may be applied to the warrant; wherein each of the installment payments is distinct from the proceeds associated with the issuance of the security. Another embodiment of the present invention relates to a security issued by an issuer, comprising: a debt of the issuer; and a warrant, which warrant has associated therewith a right to purchase a fixed number of shares of stock of the issuer; wherein proceeds from issuance of the security are allocated essentially entirely to the debt; and wherein the warrant is paid for by at least one payment distinct from the proceeds associated with the issuance of the security.

### RELATED APPLICATIONS

This application claims the benefit under 35 U.S.C. 119(e) of U.S. Provisional Application Serial No. 60/381,571, filed May 17, 2002.

### FIELD OF THE INVENTION

The present invention relates to methods for performing data processing operations associated with securities and security structures.

More particularly, one embodiment of the present invention relates to a computer implementable method for performing data processing operations associated with a security issued by an issuer, which method comprises the steps of: coupling a debt of the issuer and a warrant; structuring the warrant with the requirement to purchase a fixed number of shares of stock of the issuer; allocating proceeds from issuance of the security essentially entirely to the debt and storing data representative of the allocated proceeds; and tracking a payment status of a plurality of installment payments due on the warrant and storing data representative of the payment status so that the installment payments may be applied to the warrant; wherein each of the installment payments is distinct from the proceeds associated with the issuance of the security.

Another embodiment of the present invention relates to a security issued by an issuer, comprising: a debt of the issuer; and a warrant, which warrant has associated therewith a right to purchase a fixed number of shares of stock of the issuer; wherein proceeds from issuance of the security are allocated essentially entirely to the debt; and wherein the warrant is paid for by at least one payment distinct from the proceeds associated with the issuance of the security.

For the purposes of the present application the term “debt” is intended to include any instrument of the type known by those of ordinary skill in the art (e.g., including, but not limited to, debenture(s), note(s), and/or bond(s)).

Further, for the purposes of the present application the term “entity” is intended to refer to any person, organization, or group.

Further still, for the purposes of the present application the term “time” (e.g., as in “expiration time”) is intended to refer to when an event occurs (e.g., the hour, the minute, the day, the date, the month, and/or the year).

Further still, for the purposes of the present application the term “remarketing” is intended to refer to the resale of debt.

Further still, for the purposes of the present application the term “failed remarketing” is intended to refer to the failure to sell all debt (e.g., bonds) being remarketed for at least 100% of face value.

Further still, for the purposes of the present application the term “security” is intended to refer to an instrument evidencing debt and/or ownership of asset(s).

### BRIEF DESCRIPTION OF THE DRAWINGS

FIG. 1 shows, in connection with an embodiment of the present invention, data processing operations and a security structure associated with issuance of a security;

FIG. 2 shows, in connection with an embodiment of the present invention, data processing operations and a security structure associated with ongoing cash flows;

FIG. 3 shows, in connection with an embodiment of the present invention, data processing operations and a security structure associated with maturity (or acceleration) of a warrant; and

FIG. 4 shows a decision tree in connection with an embodiment of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

In one embodiment a computer implementable method for performing data processing operations associated with a security issued by an issuer is provided, which method comprises the steps of: coupling a debt of the issuer and a warrant; structuring the warrant with the requirement to purchase a fixed number of shares of stock of the issuer; allocating proceeds from issuance of the security essentially entirely to the debt and storing data representative of the allocated proceeds; and tracking a payment status of a plurality of installment payments due on the warrant and storing data representative of the payment status so that the installment payments may be applied to the warrant; wherein each of the installment payments is distinct from the proceeds associated with the issuance of the security.

In one example the method may further comprise recording data identifying a holder of the debt and recording data identifying a holder of the warrant.

In another example the holder of the debt and the holder of the warrant may be selected from the group including, but not limited to: (a) a single entity; and (b) a first entity and a second entity, wherein the second entity is distinct from the first entity and wherein the first entity holds the debt and the second entity holds the warrant.

In another example the method may further comprise determining a value associated with one of, but not limited to: (a) a fixed-rate coupon paid by the debt; and (b) a floating-rate coupon paid by the debt.

In another example the coupon may be a cash coupon.

In another example the coupon may be payable periodically.

In another example the coupon may be payable at a period selected from the group including, but not limited to: (a) daily; (b) weekly; (c) monthly; (d) quarterly; (e) semi-annually; and (f) annually.

In another example the warrant may be paid for by periodic installment payments made at a period selected from the group including, but not limited to: (a) daily; (b) weekly; (c) monthly; (d) quarterly; (e) semi-annually; and (f) annually.

In another example the coupon and each of the periodic installment payments for the warrant may be paid on the same periodic cycle.

In another example the coupon and each of the periodic installment payments for the warrant may be paid at essentially the same time.

In another example the steps may be carried out in the order recited.

In another embodiment a computer implementable method for performing data processing operations associated with a security issued by an issuer, which issuer is a publicly traded corporation, is provided, wherein the method comprises the steps of: coupling a debt of the issuer and a warrant; structuring the warrant with the requirement to purchase a fixed number of shares of stock of the issuer; recording data identifying a holder of the debt and recording data identifying a holder of the warrant, wherein the holder of the debt and the holder of the warrant are selected from the group including, but not limited to: (a) a single entity; and (b) a first entity and a second entity, wherein the second entity is distinct from the first entity and wherein the first entity holds the debt and the second entity holds the warrant; recording data identifying a maturity associated with the debt; recording data identifying a face value associated with the debt when the security is issued; recording data identifying an expiration time associated with the warrant; allocating proceeds from issuance of the security essentially entirely to the debt and storing data representative of the allocated proceeds; tracking a payment status of a plurality of periodic installment payments due from the warrant holder on the warrant and storing data representative of the payment status so that the installment payments may be applied to the warrant; and determining a value associated with one of, but not limited to: (a) a fixed-rate cash coupon paid by the debt; and (b) a floating-rate cash coupon paid by the debt, wherein the coupon and each periodic installment payment are payable at a period selected from the group including, but not limited to: (a) daily; (b) weekly; (c) monthly; (d) quarterly; (e) semi-annually; and (f) annually, and wherein the coupon and each of the periodic installment payments for the warrant are paid at essentially the same time; wherein each of the installment payments associated with the warrant is distinct from the proceeds associated with the issuance of the security; wherein the security obligates the issuer to cause remarketing of the debt by the expiration time of the warrant; and wherein collateral is used to support the periodic installment payments associated with the warrant.

In one example the security may obligate the issuer to cause remarketing of the debt upon the occurrence of a required acceleration event, which required acceleration event comprises a market value of the security being below a target value.

In another example the required acceleration event may comprise a market value of the security being below x percent of the value of the shares of stock of the issuer underlying the security, wherein x is less than 100.

In another example the required acceleration event may comprise a market value of the security being below x percent of the value of the shares of stock for y number of trading days, wherein y is greater than zero.

In another example the security may further provide the issuer the option to cause a voluntary acceleration event, which voluntary acceleration event causes the warrant to expire before the expiration time of the warrant.

In another example the holder of the warrant may have a right to cancel the warrant.

Inn another example the holder of the warrant may have a right to cancel the warrant at one or more predetermined times before the expiration of the warrant.

In another example the warrant may permit the holder of the warrant to purchase, at a price substantially equal to the face value of the debt, a fixed number of shares of common stock of the issuer.

In another example the security may further provide the issuer the option to cause a voluntary acceleration event, which voluntary acceleration event causes the warrant to expire before the expiration time of the warrant.

In another example the holder of the warrant may have a right to cancel the warrant.

In another example the holder of the warrant may have a right to cancel the warrant at one or more predetermined times before the expiration of the warrant.

In another example the warrant may permit the holder of the warrant to purchase, at a price substantially equal to the face value of the debt, a fixed number of shares of common stock of the issuer.

In another example the collateral may comprise coupon payments on the debt.

In another example additional collateral may be used to support the periodic installment payments associated with the warrant.

In another example the debt may be puttable by the holder of the debt for essentially the face value of the debt.

In another example the right to put the debt may occur in the event of a failed remarketing of the debt.

In another example the right to put the debt may occur at one or more predetermined times before the maturity of the debt.

In another example the steps may be carried out in the order recited.

In another embodiment a security issued by an issuer is provided, comprising: a debt of the issuer; and a warrant, which warrant has associated therewith a right to purchase a fixed number of shares of stock of the issuer; wherein proceeds from issuance of the security are allocated essentially entirely to the debt; and wherein the warrant is paid for by at least one payment distinct from the proceeds associated with the issuance of the security.

In one example the warrant may be paid for by a plurality of installment payments, each of which installment payments is distinct from the proceeds associated with the issuance of the security.

In another example the plurality of installment payments may be paid periodically.

In another example the debt may be held by a holder and the warrant may be held by a holder.

In another example the holder of the debt and the holder of the warrant may be selected from the group including, but not limited to: (a) a single entity; and (b) a first entity and a second entity, wherein the second entity is distinct from the first entity and wherein the first entity holds the debt and the second entity holds the warrant.

In another example the debt may pay one of, but not limited to: (a) a fixed-rate coupon; and (b) a floating-rate coupon.

In another example the coupon may be a cash coupon.

In another example the coupon may be payable periodically.

In another example the coupon may be payable at a period selected from the group including, but not limited to: (a) daily; (b) weekly; (c) monthly; (d) quarterly; (e) semi-annually; and (f) annually.

In another example the warrant may be paid for by periodic installment payments made at a period selected from the group including, but not limited to: (a) daily; (b) weekly; (c) monthly; (d) quarterly; (e) semi-annually; and (f) annually.

In another example the coupon and each of the periodic installment payments for the warrant may be paid on the same periodic cycle.

In another example the coupon and each of the periodic installment payments for the warrant may be paid at essentially the same time.

In another embodiment a security issued by an issuer, which issuer is a publicly traded corporation, is provided, comprising: a debt of the issuer; and a warrant, which warrant has associated therewith a right to purchase a fixed number of shares of common stock of the issuer; wherein the debt is held by a holder and the warrant is held by a holder; wherein the holder of the debt and the holder of the warrant are selected from the group including, but not limited to: (a) a single entity; and (b) a first entity and a second entity, wherein the second entity is distinct from the first entity and wherein the first entity holds the debt and the second entity holds the warrant; wherein proceeds from issuance of the security are allocated essentially entirely to the debt; wherein the holder of the warrant pays for the warrant by a plurality of periodic installment payments, each of which installment payments is distinct from the proceeds associated with the issuance of the security; wherein the debt has associated therewith a maturity; wherein the debt has associated therewith a face value when the security is issued; wherein the warrant has associated therewith an expiration time; wherein the debt pays one of, but not limited to: (a) a fixed-rate cash coupon; and (b) a floating-rate cash coupon; wherein the coupon and each periodic installment payment are payable periodically at a period selected from the group including, but not limited to: (a) daily; (b) weekly; (c) monthly; (d) quarterly; (e) semi-annually; and (f) annually; wherein the coupon and each of the periodic installment payments for the warrant are paid at essentially the same time; wherein the security obligates the issuer to cause remarketing of the debt by the expiration time of the warrant; and wherein collateral is used to support the periodic installment payments associated with the warrant.

In one example the security may obligate the issuer to cause remarketing of the debt upon the occurrence of a required acceleration event, which required acceleration event comprises a market value of the security being below a target value.

In another example the required acceleration event may comprise a market value of the security being below x percent of the value of the shares of stock of the issuer underlying the security, wherein x is less than 100.

In another example the required acceleration event may comprise a market value of the security being below x percent of the value of the shares of stock for y number of trading days, wherein y is greater than zero.

In another example the security may further provide the issuer the option to cause a voluntary acceleration event, which voluntary acceleration event causes the warrant to expire before the expiration time of the warrant.

In another example the holder of the warrant may have a right to cancel the warrant.

In another example the holder of the warrant may have a right to cancel the warrant at one or more predetermined times before the expiration of the warrant.

In another example the warrant may permit the holder of the warrant to purchase, at a price substantially equal to the face value of the debt, a fixed number of shares of common stock of the issuer.

In another example the security may further provide the issuer the option to cause a voluntary acceleration event, which voluntary acceleration event causes the warrant to expire before the expiration time of the warrant.

In another example the holder of the warrant may have a right to cancel the warrant.

In another example the holder of the warrant may have a right to cancel the warrant at one or more predetermined times before the expiration of the warrant.

In another example the warrant may permit the holder of the warrant to purchase, at a price substantially equal to the face value of the debt, a fixed number of shares of common stock of the issuer.

In another example the collateral may comprise coupon payments on the debt.

In another example additional collateral may be used to support the periodic installment payments associated with the warrant.

In another example the debt may be puttable by the holder of the debt for essentially the face value of the debt.

In another example the right to put the debt may occur in the event of a failed remarketing of the debt.

In another example the right to put the debt may occur at one or more predetermined times before the maturity of the debt.

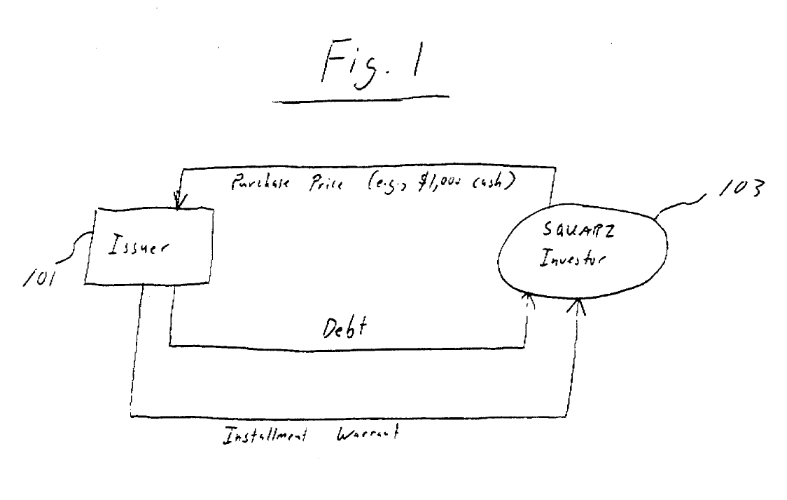

Referring now to FIG. 1, one embodiment of the present invention is shown. As seen in this FIG. 1, Issuer 101 issues an Investment Unit (hereinafter sometimes referred to as a SQUARZ or a SQUARZ security). The SQUARZ security comprises debt (e.g., one debenture) and a warrant. SQUARZ Investor 103 purchases the SQUARZ security for the face value of the debt (e.g., $1,000) and the purchase price is allocated entirely to the debt. Rather than paying for the warrant at the time of issuance, SQUARZ Investor 103 makes installment payments on the warrant (e.g., over the term of the warrant and/or the SQUARZ security). The debt (i.e., coupon payments on the debt) serves as collateral to secure the obligation of SQUARZ Investor 103 to make the required installment payments on the warrant.

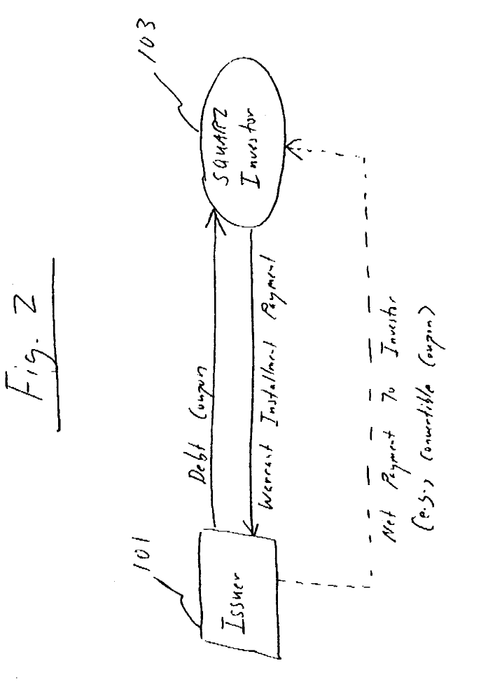

Referring now to FIG. 2, ongoing cash flows associated with the embodiment of FIG. 1 are shown. As seen in this FIG. 2, the debt will pay a coupon (e.g., a quarterly cash coupon). This coupon may be based on a “straight” (i.e., non-convertible) debt rate of Issuer 101. SQUARZ Investor 103 will make installment payments (e.g., quarterly cash installment payments) on the warrant. As seen by the dashed line in this FIG. 2, the “net” to SQUARZ Investor 103 may equal the coupon (e.g., cash coupon) that Issuer 101 would pay on a conventional (unitary) convertible instrument.

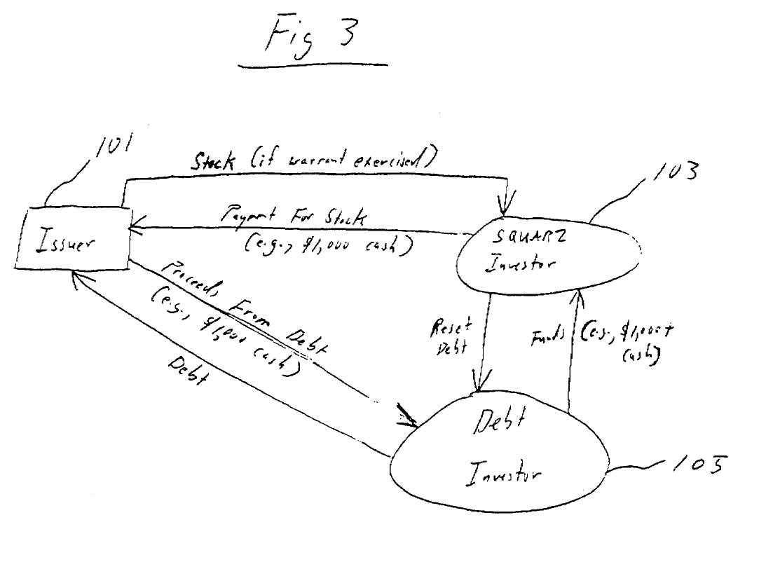

Referring now to FIG. 3, it is seen that under the embodiment of FIG. 1, upon maturity (or acceleration) of a warrant:

The interest rate on the debt is reset and the debt is remarketed for x% (e.g., at least 100%) of face value

A portion of remarketing proceeds (e.g., 25 bp) are remitted to marketing agent

A warrant holder (e.g., SQUARZ Investor) receives proceeds from the remarketing, which can be used to exercise the warrant

If the warrant is out of the money, it simply expires worthless

Debt matures later (e.g., 6 months later)

New investors who purchased the debt in the remarketing receive cash equal to the face value of the debt from the Issuer

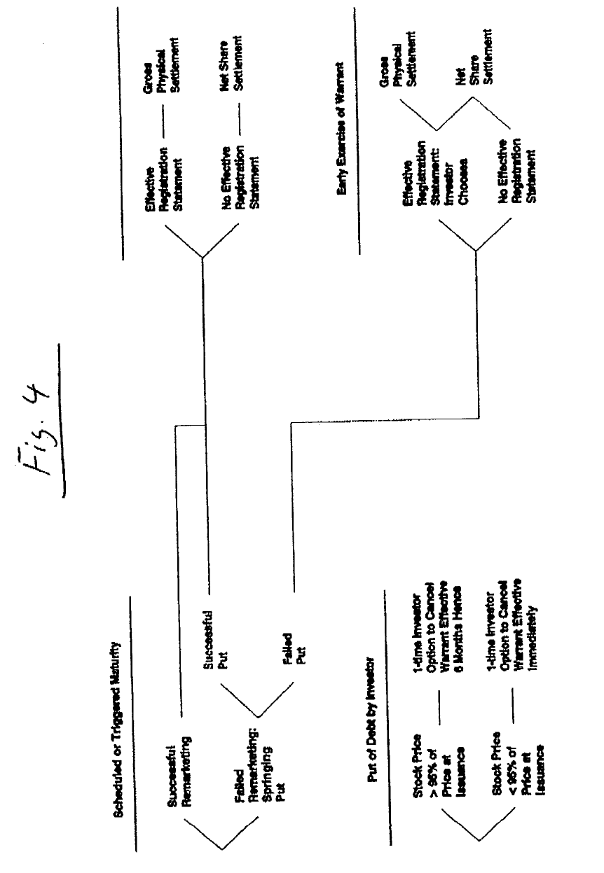

Referring now to FIG. 4, a decision tree relating to remarketing, puts, warrant exercise, registration statements, and settlement is shown.

Another embodiment of the present invention may relate to an Investment Unit (i.e., a SQUARZ security) consisting of: (i) one debenture (the “debt”) and (ii) one warrant to purchase a fixed number of shares of issuer stock (the “warrant”). In one example (which example is intended to be illustrative and not restrictive) the stock may be common stock and the issuer may be a publicly traded corporation. In another example (which example is intended to be illustrative and not restrictive) the SQUARZ security may be offered in connection with a registered offering or a 144A (with registration rights).

The proceeds from issuance of the SQUARZ security may be allocated based on fair market values of the debt and the warrant (as a result, under this embodiment the proceeds may be allocated entirely to the debt). In addition, an investor in an SQUARZ security may make installment payments on the warrant over the term of the warrant (rather than paying for the warrant at the time of issuance).

Additional characteristics of the SQUARZ security according to this embodiment of the present invention may include the following:

Maturity

The debt may have associated therewith a maturity (which maturity may be subject to acceleration if there is a Remarketing Event (see below)). In one example (which example is intended to be illustrative and not restrictive), the debt may mature 5 years and 6 months after issuance of the SQUARZ security. Further, the warrant may have associated therewith a maturity (i.e., an expiration). The expiration of the warrant may be subject to acceleration by the issuer (see below) and in one example (which example is intended to be illustrative and not restrictive) the warrant may expire 5 years after issuance of the SQUARZ security.

Principal Terms of Debt

The debt may have associated therewith a face value. In one example (which example is intended to be illustrative and not restrictive) the face value may be $1,000. Further, the debt may pay a coupon. In one example (which example is intended to be illustrative and not restrictive) the debt may pay a floating-rate, cash coupon of LIBOR+x% per annum, payable quarterly (under this example the coupon may be reset (e.g., quarterly) based on, for example, 3-month LIBOR (subject to a floor, for example, of y%.). In another example (which example is intended to be illustrative and not restrictive) the debt may pay a fixed-rate, cash coupon of k% per annum, payable semi-annually. Further, in addition to any other investor put rights described below, the debt may be puttable by an investor (e.g., for face value) in the event of a failed remarketing.

Investor Put Right on Debt

The debt may be puttable by an investor (e.g., for face value) at certain time(s) between the issuance of the SQUARZ security and the maturity date of the debt. In one example (which example is intended to be illustrative and not restrictive) the debt may be puttable by an investor (e.g., for face value) at certain time(s) provided, however, that an investor may exercise this put right only if the stock price of the stock (e.g., common stock of the issuer) for x number of days (e.g., 20 days) out of y number of days (e.g., 30 consecutive trading days) ending on the put date: (i) is less than the stock price at the time of issuance of the SQUARZ security; or (ii) is greater than k% (e.g., 200%) of the stock price at the time of issuance of the SQUARZ security. In this regard, the more limited put right may allow an investor to put only when the stock is down (so that the warrant is out of the money) or when the stock is way up (so that the warrant is deep in the money).

Principal Terms of Warrant

Each warrant may give the holder thereof the right to purchase x shares of stock of the issuer (e.g., x shares of common stock of the issuer) at a certain price (e.g., at a price equal to the face value of the debt). In one example (which example is intended to be illustrative and not restrictive) a holder may exercise a warrant at any time prior to maturity of the warrant or earlier acceleration, provided, however, that in this example a warrant may not be exercised during the x day (e.g., 60 day) period commencing y days (e.g., 30 days) prior to an investor put date with respect to the debt and ending z days (e.g., 30 days) after such put date.

A warrant holder may be required to make installment payments to the issuer until maturity of the warrant or earlier acceleration of the warrant by the issuer, subject to certain exceptions. In one example (which example is intended to be illustrative and not restrictive) a warrant holder may be required to make quarterly installment payments of x% per annum. A holder generally will not be required to make installment payments following exercise or cancellation of a warrant. However, in one example (which example is intended to be illustrative and not restrictive) if a holder exercises or cancels a warrant on a date other than a warrant installment payment date, the full amount of the warrant installment payment due on the first payment date after exercise or cancellation will be payable in connection with such exercise or cancellation (except that if a holder exercises a warrant in connection with a Required Acceleration Event (see below), only the accrued amount of the warrant installment payment up to such exercise date will be due). In a further example (which example is intended to be illustrative and not restrictive) in the case of a Voluntary Acceleration Event (see below), a holder will be required to pay the accrued value of the warrant installment payment up to the early expiration date of the warrant (whether or not the holder exercises the warrant).

If a holder fails to make a required installment payment on a warrant, that holder's warrant will, in one example (which example is intended to be illustrative and not restrictive), become null and void. In another example (which example is intended to be illustrative and not restrictive) a holder's obligation to make installment payments on a warrant is recourse only to the extent of the collateral securing such payment obligations (i.e., under this example the obligation is not otherwise recourse to a holder).

Warrant Exercise

A holder may exercise a warrant prior to maturity of the warrant or earlier acceleration (in either case “early exercise”). In one example (which example is intended to be illustrative and not restrictive) a holder who elects to early exercise may use cash to exercise a warrant, provided there is an effective registration statement. Alternatively, such a holder may elect, upon x days notice, to net-share settle his Warrant, in which case a holder may exercise his warrant whether or not there is an effective registration statement. In one example (which example is intended to be illustrative and not restrictive) all net-share exercises of a arrant will be based on the average reported closing price of the common stock for y trading days following notice of net-share settlement and immediately preceding the exercise date.

A holder who chooses to exercise his warrant at maturity or upon the occurrence of an Acceleration Event (whether Voluntary or Required) may be required to tender cash to exercise his warrant (but note that in the event of a failed remarketing, the debt may be puttable by investors for face value), provided, however, that if issuer does not have an effective registration statement at that time, a holder may be required to net-share settle his warrant, and further provided that in the event of a failed remarketing if a holder exercises his put right but issuer is unable to satisfy its obligation to pay such holder the face value of the debt, such holder may elect to net-share settle his warrant.

Warrant Cancellation

A warrant holder may have the right to cancel his warrant. In one example (which example is intended to be illustrative and not restrictive) a warrant may be cancelled on one or more scheduled warrant cancellation dates. In another example (which example is intended to be illustrative and not restrictive) such warrant cancellation dates may generally be x months (e.g., 3 months) preceding an investor put date with respect to the debt. In one example (which example is intended to be illustrative and not restrictive), if a holder chooses to cancel his warrant, he will not be required to make warrant installment payments following such cancellation; provided, however, that if a holder cancels his warrant on a date other than a warrant installment payment date, the full amount of the warrant installment payment due on the first payment date after cancellation may be payable in connection with such cancellation.

Collateralization of Warrant Installment Payments

The debt (e.g., to the extent of the interest payments) may initially be pledged as collateral to support the warrant payment obligations. To the extent the interest payment on the debt exceeds the warrant installment payment on any given payment date, such excess may be paid to a holder (e.g., the issuer may be required to pay the full coupon on the debt (i.e., make a “gross payment”); however, to the extent that the debt is pledged as collateral for the warrant installment payment obligations, the collateral agent may receive any interest payments made by the issuer on the debt and then the collateral agent may effectively “net” the debt and the warrant payments, giving the investor the excess (if any) of interest on the debt over the warrant installment payment and/or giving the issuer the excess (if any) of the warrant installment payment over the interest on the debt). Upon maturity or early expiration of a warrant, or if a holder elects to early exercise or cancel his warrant, the debt may be released to the holder.

To the extent the installment payment on the warrant exceeds the cash interest paid by issuer on the debt, an investor may be required to pledge additional collateral (e.g., zero-coupon U.S. Treasury Securities) to support the warrant payment obligations. A holder may be obligated to pledge Treasury Securities that mature, for example, on each of the warrant installment dates through the stated maturity of the warrant (e.g., year 5), such that the total principal amount of the Treasury Securities is sufficient to fund the excess of: (i) the aggregate of a holder's installment payments through the stated maturity of the warrant over (ii) the aggregate of the cash interest paid by the issuer during that same period; and such that the principal amount of any Treasury Securities maturing on a given installment payment date will be equal to the excess of: (i) that warrant installment payment over (ii) the cash interest payment by the issuer on that date. If a holder elects to early exercise his warrant or to cancel his warrant, any excess collateral may be refunded to that holder. Similarly, at maturity or upon issuer acceleration of a warrant, any excess collateral may be refunded to an investor.

The debt coupon may have a floor of at least 0%, in which case an investor may have to pledge additional collateral upfront to the extent that the warrant installment payment exceeded that debt floor. If at any time the debt coupon was above the floor (so that the warrant was over-collateralized) the investor may be entitled to a refund of the excess collateral.

Acceleration of Warrant/Remarketing of Debt

The issuer may have the option (e.g., beginning at a certain time, such as after year 1 for example) to cause one or more warrants to expire on certain notice (e.g., 30 days notice). Such expiration may hereinafter be referred to as a Voluntary Acceleration Event.

In addition, a Required Acceleration Event may occur if, at any time during a pricing period requested by a holder, the market value of the SQUARZ security is less than x percent (for example, 90%-99%; more specifically, for example, 95%) of parity (i.e., the value of the common stock underlying such SQUARZ security) for y (e.g., 10) consecutive trading days. Issuer may be required to provide notice (e.g., 30 days notice) upon the occurrence of a Required Acceleration Event, and following such notice the interest rate on the debt may be reset and the debt may be remarketed (as described below). The warrant(s) may continue to mature at their scheduled maturity date(s). Accordingly, in one example (which example is intended to be illustrative and not restrictive) a warrant holder may be required to pledge substitute collateral (e.g., U.S. Treasury Securities) to secure the remaining warrant installment payment obligations (unless a holder elects to exercise his warrant in connection with the Required Acceleration Event).

Upon an Acceleration Event (whether Voluntary or Required), a holder who chooses to exercise a warrant may be required to use cash to exercise the warrant, provided however, that if the issuer does not have an effective registration statement, a holder who chooses to exercise a warrant may be required to net-share settle the warrant, and further provided that in the event of a failed remarketing if a holder exercises his put right on the debt but the issuer is unable to satisfy its obligation to pay such holder the face value of the debt, such holder may elect net-share settlement of a warrant.

In connection with an Acceleration Event (whether Voluntary or Required), the debt may be remarketed by a remarketing agent selected by the issuer. The maturity of the debt may be accelerated such that the debt will mature x months (e.g., 6 months) following the remarketing date, and the interest rate on the debt may be reset such that the debt can be remarketed at a price equal to at least x% (e.g., about 100.25%-100.5%) of the face value (the remarketing may fail if the remarketing agent is unable to sell all of the debt (e.g., all of the bonds submitted for remarketing) for at least 100% (or higher, if desired) of face value). The remarketing agent may deduct as a remarketing fee an amount not exceeding y basis points (e.g., 25 basis points) of the total proceeds from such remarketing, with the remaining proceeds from the remarketing being paid to selling holder(s). In the event of a failed remarketing, the debt may become puttable by investor(s) for face value. To the extent investor(s) do not exercise this put right, the debt may mature z months (e.g., 6 months) following the remarketing date, but the interest rate may not necessarily be reset and may remain at its initial level.

Absent an Acceleration Event, the interest rate on the debt may be reset and the debt may be remarketed (as described above) upon maturity of the warrant(s).

Separatability

The debt and warrant may be separated and sold or traded separately following issuance (this separatability of the debt and warrant may be subject to the requirement to substitute alternative collateral (see “Substitution of Pledged Securities” below). An investor who wishes to separate debt and warrant by selling the debt may submit a Resale Notice to the issuer. In one example (which example is intended to be illustrative and not restrictive) the issuer may specify certain dates upon which this notice may be submitted. If investor(s) representing x% (e.g., 25%) of the outstanding debt submit such a Resale Notice, the Issuer may cause the Resale Agent to remarket the debt (but not necessarily reset the interest rate) on behalf of such investor(s).

Substitution of Pledged Securities

Each holder may have the right (e.g., prior to a remarketing of the debt) to substitute for the debt held by the collateral agent other collateral. In one example (which example is intended to be illustrative and not restrictive) each holder may have the right to substitute zero-coupon U.S. Treasury Securities that mature on each of the remaining warrant installment payment dates through the stated maturity of a warrant (e.g., year 5)), such that the total principal amount of the Treasury Securities is sufficient to fund the aggregate of the holder's remaining installment payments through the stated maturity of the warrant and such that the principal amount of any Treasury Securities maturing on a given installment date will be equal to that warrant installment payment. Such Treasury Securities may be substituted for the debt and may be pledged to the collateral agent to secure the holder's obligation to make any remaining installment payments under the warrant. Upon maturity, exercise, or cancellation of a warrant, any excess collateral may be refunded to the investor.

Default or Bankruptcy

If the issuer defaults on an interest payment on the debt, a warrant holder may have the right to cancel a warrant, and upon such cancellation the holder may be relieved of the obligation to make any warrant installment payments. If a holder does not cancel the warrant, to the extent such holder has pledged debt as collateral and has not already pledged substitute collateral (e.g., Treasury Securities), such holder may be required to pledge substitute collateral (e.g., Treasury Securities) to secure its obligations to make warrant installment payments (as the debt will no longer be good collateral). In the case of bankruptcy of the issuer prior to maturity of a warrant, the warrant may cancel automatically and upon such cancellation the obligation of a holder to make warrant installment payments may cease.

In another embodiment, an investor may exercise a warrant as follows:

At any time by tendering cash, provided:

An investor who exercises early (i.e., before maturity of the warrant or acceleration) may elect to use cash or to net-share settle the warrant

An investor will be required to net-share settle if the issuer does not have an effective registration statement

At maturity or acceleration of a warrant, an investor will be required to use cash to exercise the warrant (except that an investor will be required to net-share settle if the issuer does not have an effective registration statement).

In another embodiment, debt may be put back to the issuer as follows:

For face value at certain dates

Upon exercise of a put right, there will be a right to cancel a warrant as follows:

If stock price on put date is less than x% (e.g., 95%) of stock price at issuance, the warrant can be immediately cancelled

If stock price on put date is greater than x% (e.g., 95%) of stock price at issuance, the warrant can be cancelled after a certain time (e.g., 6 months later)

In another embodiment, a SQUARZ security may receive the following accounting treatment:

The SQUARZ security may be treated as a unit consisting of a separate debt and a separate warrant (wherein the issuer is treated as having separately issued the debt and the warrant, rather than having issued a single convertible security).

The SQUARZ security may not be subject to the new rules for convertible securities under the pending Liabilities & Equity project. Thus, there may be:

No gain or loss upon conversion (i.e., exercise of a warrant)

No bifurcation of a put, since it is believed that any puts should be “clearly and closely related” to the debt given that the puts are at carrying value of the debt

Issuer may show debt on balance sheet in an amount equal to the face value of the debt

Issuer may show interest expense based on coupon on the debt

Issuer may show interest expense in excess of net convertible coupon, as interest may be based on straight line debt

While interest expense may be higher than that for a conventional convertible under current accounting rules, the Liabilities & Equities project may likely produce a similar result for conventional convertibles

Warrant installment payments as received may be booked to shareholder's equity

Warrant may be accounted for using “treasury stock method”

Issuer may not show incremental shares outstanding until stock price increases above conversion premium

In another embodiment, a SQUARZ security may receive the following tax treatment:

The SQUARZ security may be treated as an investment unit consisting of a separate debt and a separate warrant

Interest payments on the debt may be fully tax deductible

Interest deductions may be based on the stated coupon on the debt

Installment payments on the warrant received by the issuer may not be taxable and, it is believed, should not reduce the interest deduction received by the issuer on the debt

In another embodiment, a SQUARZ security may be treated as an investment unit consisting of a separate debt and a separate warrant for U.S. tax purposes. The issuer may be entitled to tax deduction(s) on the debt (treated as a stand-alone instrument) based on the stated coupon on the debt. Installment payments received by the issuer may not be taxable. In addition, such installment payments may not reduce the interest deduction received by the issuer on the debt.

In another embodiment, a SQUARZ security may be treated as an investment unit consisting of a separate debt and a separate warrant for accounting purposes. The issuer may be required to book the debt at its face value. Initially, there may be no value ascribed to the installment warrant. As issuer receives warrant installment payments, such proceeds may be booked to shareholder's equity. The installment warrants may be accounted for under the “treasury stock method”.

In another embodiment, a SQUARZ security may be treated as an investment unit consisting of a separate debt and a separate installment warrant, wherein:

Economics of the SQUARZ security are substantially similar to those of conventional convertible debt securities (but the use of a unit structure may provide certain accounting and/or tax benefits)

Issuer pays a quarterly cash coupon on the debt based on its straight debt rate

Investors make quarterly cash installment payments on a warrant

Net cash flow to investors equals the cash coupon investors would receive on a comparable convertible debt instrument

The SQUARZ security may avoid certain adverse consequences of FASB's pending Liabilities & Equities project

Accounted for using “treasury stock method”

No incremental shares outstanding until warrant is in the money

Use of unit structure may allow issuer to receive enhanced tax deductions

Issuer receives interest deductions based on straight debt rate rather than lower convertible coupon

Debt remains outstanding for a period following warrant exercise or maturity

“Treasury stock method” accounting may not be as attractive for certain higher PE companies

Interest expense shown on income statement based on straight debt rate, rather than lower convertible coupon

Pending Liabilities & Equities project may yield a similar result, although interest expense may be slightly lower as it is believed that debt would likely be deemed to have been issued at a discount

In another embodiment, the issuer may be required to make all gross payments required under the terms of the debt. For example (which example is intended to be illustrative and not restrictive), the issuer may be required to pay the full coupon on the debt and may not be permitted to net the warrant installment payments owed by an investor against the coupon payable by the issuer. Similarly, in another example (which example is intended to be illustrative and not restrictive) the issuer may be required to pay face value of the debt to an investor who exercises its put right in the event of a failed remarketing, whether or not such investor also chooses to exercise a warrant.

Of note, the method embodiments described herein may, of course, be implemented using any appropriate computer hardware and/or computer software. In this regard, those of ordinary skill in the art are well versed in the type of computer hardware that may be used (e.g., a mainframe, a mini-computer, a personal computer (“PC”), a network (e.g., an intranet and/or the Internet)), the type of computer programming techniques that may be used (e.g., object oriented programming), and the type of computer programming languages that may be used (e.g., C++, basic). The aforementioned examples are, of course, illustrative and not restrictive.

While a number of embodiments of the present invention have been described, it is understood that these embodiments are illustrative only, and not restrictive, and that many modifications may become apparent to those of ordinary skill in the art. For example, certain methods have been described herein as being “computer implementable”. In this regard it is noted that while such methods can be implemented using a computer, the methods do not necessarily have to be implemented using a computer. Also, to the extent that such methods are implemented using a computer, not every step must necessarily be implemented using a computer. Further, a SQUARZ security may comprise a plurality of debt instruments and/or a plurality of warrants. Further still, while the invention has been described principally with respect to one issuer and one investor, any number of issuers and/or investors may be involved.

What is claimed is:

1. A computer implementable method for performing data processing operations associated with a security issued by an issuer comprises the steps of:
coupling a debt of the issuer and a warrant;
structuring the warrant with the requirement to purchase a fixed number of shares of stock of the issuer;
allocating proceeds from issuance of the security essentially entirely to the debt and storing data representative of the allocated proceeds; and
tracking a payment status of a plurality of installment payments due on the warrant and storing data representative of the payment status so that the installment payments may be applied to the warrant;
wherein each of the installment payments is distinct from the proceeds associated with the issuance of the security.

2. The method of claim 1, further comprising recording data identifying a holder of the debt and recording data identifying a holder of the warrant.

3. The method of claim 2, wherein the holder of the debt and the holder of the warrant are selected from the group of: (a) a single entity; and (b) a first entity and a second entity, wherein the second entity is distinct from the first entity and wherein the first entity holds the debt and the second entity holds the warrant.

4. The method of claim 3, further comprising determining a value associated with one of: (a) a fixed-rate coupon paid by the debt; and (b) a floating-rate coupon paid by the debt.

5. The method of claim 4, wherein the coupon is a cash coupon.

6. The method of claim 5, wherein the coupon is payable periodically.

7. The method of claim 6, wherein the coupon is payable at a period selected from the group of: (a) daily; (b) weekly; (c) monthly; (d) quarterly; (e) semi-annually; and (f) annually.

8. The method of claim 7, wherein the warrant is paid for by periodic installment payments made at a period selected from the group of: (a) daily; (b) weekly; (c) monthly; (d) quarterly; (e) semi-annually; and (f) annually.

9. The method of claim 8, wherein the coupon and each of the periodic installment payments for the warrant are paid on the same periodic cycle.

10. The method of claim 9, wherein the coupon and each of the periodic installment payments for the warrant are paid at essentially the same time.

11. The method of claim 1, wherein the steps are carried out in the order recited.

12. A computer implementable method for performing data processing operations associated with a security issued by an issuer, which issuer is a publicly traded corporation, wherein the method comprises the steps of:
coupling a debt of the issuer and a warrant;
structuring the warrant with the requirement to purchase a fixed number of shares of stock of the issuer;
recording data identifying a holder of the debt and recording data identifying a holder of the warrant, wherein the holder of the debt and the holder of the warrant are selected from the group of: (a) a single entity; and (b) a first entity and a second entity, wherein the second entity is distinct from the first entity and wherein the first entity holds the debt and the second entity holds the warrant;
recording data identifying a maturity associated with the debt;
recording data identifying a face value associated with the debt when the security is issued;
recording data identifying an expiration time associated with the warrant; allocating proceeds from issuance of the security essentially entirely to the debt and storing data representative of the allocated proceeds;
tracking a payment status of a plurality of periodic installment payments due from the warrant holder on the warrant and storing data representative of the payment status so that the installment payments may be applied to the warrant; and
determining a value associated with one of: (a) a fixed-rate cash coupon paid by the debt; and (b) a floating-rate cash coupon paid by the debt, wherein the coupon and each periodic installment payment are payable at a period selected from the group of: (a) daily; (b) weekly; (c) monthly; (d) quarterly; (e) semi-annually; and (f) annually, and wherein the coupon and each of the periodic installment payments for the warrant are paid at essentially the same time;
wherein each of the installment payments associated with the warrant is distinct from the proceeds associated with the issuance of the security;
wherein the security obligates the issuer to cause remarketing of the debt by the expiration time of the warrant; and
wherein collateral is used to support the periodic installment payments associated with the warrant.

13. The method of claim 12, wherein the security obligates the issuer to cause remarketing of the debt upon the occurrence of a required acceleration event, which required acceleration event comprises a market value of the security being below a target value.

14. The method of claim 13, wherein the required acceleration event comprises a market value of the security being below x percent of the value of the shares of stock of the issuer underlying the security, wherein x is less than 100.

15. The method of claim 14, wherein the required acceleration event comprises a market value of the security being below x percent of the value of the shares of stock for y number of trading days, wherein y is greater than zero.

16. The method of claim 15, wherein the security further provides the issuer the option to cause a voluntary acceleration event, which voluntary acceleration event causes the warrant to expire before the expiration time of the warrant.

17. The method of claim 16, wherein the holder of the warrant has a right to cancel the warrant.

18. The method of claim 17, wherein the holder of the warrant has a right to cancel the warrant at one or more predetermined times before the expiration of the warrant.

19. The method of claim 18, wherein the warrant permits the holder of the warrant to purchase, at a price substantially equal to the face value of the debt, a fixed number of shares of common stock of the issuer.

20. The method of claim 12, wherein the security further provides the issuer the option to cause a voluntary acceleration event, which voluntary acceleration event causes the warrant to expire before the expiration time of the warrant.

21. The method of claim 12, wherein the holder of the warrant has a right to cancel the warrant.

22. The method of claim 21, wherein the holder of the warrant has a right to cancel the warrant at one or more predetermined times before the expiration of the warrant.

23. The method of claim 12, wherein the warrant permits the holder of the warrant to purchase, at a price substantially equal to the face value of the debt, a fixed number of shares of common stock of the issuer.

24. The method of claim 12, wherein the collateral comprises coupon payments on the debt.

25. The method of claim 24, wherein additional collateral is used to support the periodic installment payments associated with the warrant.

26. The method of claim 12, wherein the debt is puttable by the holder of the debt for essentially the face value of the debt.

27. The method of claim 26, wherein the right to put the debt occurs in the event of a failed remarketing of the debt.

28. The method of claim 26, wherein the right to put the debt occurs at one or more predetermined times before the maturity of the debt.

29. The method of claim 12, wherein the steps are carried out in the order recited.

30. A security issued by an issuer, comprising:
a debt of the issuer; and
a warrant, which warrant has associated therewith a right to purchase a fixed number of shares of stock of the issuer;
wherein proceeds from issuance of the security are allocated essentially entirely to the debt; and
wherein the warrant is paid for by at least one payment distinct from the proceeds associated with the issuance of the security.

31. The security of claim 30, wherein the warrant is paid for by a plurality of installment payments, each of which installment payments is distinct from the proceeds associated with the issuance of the security.

32. The security of claim 31, wherein the plurality of installment payments are paid periodically.

33. The security of claim 32, wherein the debt is held by a holder and the warrant is held by a holder.

34. The security of claim 33, wherein the holder of the debt and the holder of the warrant are selected from the group of: (a) a single entity; and (b) a first entity and a second entity, wherein the second entity is distinct from the first entity and wherein the first entity holds the debt and the second entity holds the warrant.

35. The security of claim 34, wherein the debt pays one of: (a) a fixed-rate coupon; and (b) a floating-rate coupon.

36. The security of claim 35, wherein the coupon is a cash coupon.

37. The security of claim 36, wherein the coupon is payable periodically.

38. The security of claim 37, wherein the coupon is payable at a period selected from the group of: (a) daily; (b) weekly; (c) monthly; (d) quarterly; (e) semi-annually; and (f) annually.

39. The security of claim 38, wherein the warrant is paid for by periodic installment payments made at a period selected from the group of: (a) daily; (b) weekly; (c) monthly; (d) quarterly; (e) semi-annually; and (f) annually.

40. The security of claim 39, wherein the coupon and each of the periodic installment payments for the warrant are paid on the same periodic cycle.

41. The security of claim 40, wherein the coupon and each of the periodic installment payments for the warrant are paid at essentially the same time.

42. A security issued by an issuer, which issuer is a publicly traded corporation, comprising:
a debt of the issuer; and
a warrant, which warrant has associated therewith a right to purchase a fixed number of shares of common stock of the issuer;
wherein the debt is held by a holder and the warrant is held by a holder;
wherein the holder of the debt and the holder of the warrant are selected from the group of: (a) a single entity; and (b) a first entity and a second entity, wherein the second entity is distinct from the first entity and wherein the first entity holds the debt and the second entity holds the warrant;
wherein proceeds from issuance of the security are allocated essentially entirely to the debt;
wherein the holder of the warrant pays for the warrant by a plurality of periodic installment payments, each of which installment payments is distinct from the proceeds associated with the issuance of the security;
wherein the debt has associated therewith a maturity;
wherein the debt has associated therewith a face value when the security is issued;
wherein the warrant has associated therewith an expiration time;
wherein the debt pays one of: (a) a fixed-rate cash coupon; and (b) a floating-rate cash coupon;
wherein the coupon and each periodic installment payment are payable periodically at a period selected from the group of: (a) daily; (b) weekly; (c) monthly; (d) quarterly; (e) semi-annually; and (f) annually;
wherein the coupon and each of the periodic installment payments for the warrant are paid at essentially the same time;
wherein the security obligates the issuer to cause remarketing of the debt by the expiration time of the warrant; and
wherein collateral is used to support the periodic installment payments associated with the warrant.

43. The security of claim 42, wherein the security obligates the issuer to cause remarketing of the debt upon the occurrence of a required acceleration event, which required acceleration event comprises a market value of the security being below a target value.

44. The security of claim 43, wherein the required acceleration event comprises a market value of the security being below x percent of the value of the shares of stock of the issuer underlying the security, wherein x is less than 100.

45. The security of claim 44, wherein the required acceleration event comprises a market value of the security being below x percent of the value of the shares of stock for y number of trading days, wherein y is greater than zero.

46. The security of claim 45, wherein the security further provides the issuer the option to cause a voluntary acceleration event, which voluntary acceleration event causes the warrant to expire before the expiration time of the warrant.

47. The security of claim 46, wherein the holder of the warrant has a right to cancel the warrant.

48. The security of claim 47, wherein the holder of the warrant has a right to cancel the warrant at one or more predetermined times before the expiration of the warrant.

49. The security of claim 48, wherein the warrant permits the holder of the warrant to purchase, at a price substantially equal to the face value of the debt, a fixed number of shares of common stock of the issuer.

50. The security of claim 42, wherein the security further provides the issuer the option to cause a voluntary acceleration event, which voluntary acceleration event causes the warrant to expire before the expiration time of the warrant.

51. The security of claim 42, wherein the holder of the warrant has a right to cancel the warrant.

52. The security of claim 51, wherein the holder of the warrant has a right to cancel the warrant at one or more predetermined times before the expiration of the warrant.

53. The security of claim 42, wherein the warrant permits the holder of the warrant to purchase, at a price substantially equal to the face value of the debt, a fixed number of shares of common stock of the issuer.

54. The security of claim 42, wherein the collateral comprises coupon payments on the debt.

55. The security of claim 54, wherein additional collateral is used to support the periodic installment payments associated with the warrant.

56. The security of claim 42, wherein the debt is puttable by the holder of the debt for essentially the face value of the debt.

57. The security of claim 56, wherein the right to put the debt occurs in the event of a failed remarketing of the debt.

58. The security of claim 56, wherein the right to put the debt occurs at one or more predetermined times before the maturity of the debt.
